(19) United States
(12) Patent Application Publication
(10) Pub. No.: US 2007/0074022 A1
(43) Pub. Date: Mar. 29, 2007

(54) Method for providing message transmission in H.323 communication system

(75) Inventors: Qi Wang, Shenzhen (CN); Xiaosong Lei, Shenzhen (CN); Chaohui Ma, Shenzhen (CN); Haifeng Wang, Shenzhen (CN); Bo Wu, Shenzhen (CN); Haiyang Liu, Shenzhen (CN); Qin Zhang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/491,006

(22) Filed: Jul. 21, 2006

Related U.S. Application Data
(63) Continuation of application No. PCT/CN05/00146, filed on Feb. 2, 2005.

(30) Foreign Application Priority Data
Feb. 7, 2004 (CN) 200410004124.3

(51) Int. Cl. H04L 9/00

(52) U.S. Cl. 713/169

(57) ABSTRACT

The present invention provides a method for providing message transmission in H.323 communication system. The method includes: the first endpoint and second endpoint confirming authentication information through a GK; according to said authentication information, the first endpoint and second endpoint exchanging message directly. Since H.235 protocol of ITU-T describes the authentication and privacy technique used in H.323 systems and provides security service for message transmission in GK-routed model, the present invention can guarantee the security of the authentication information. The functions of middle entities need not to be modified for applying the method provided by the present invention because Diffie-Hellman key exchange technology is adopted in this method. The present invention increases the network scalability of the symmetric key system by adopting negotiation mode. The present invention designates and improves the security framework of message transmission in direct-routed model of H.323 system, thereby improving the security of H.323 system.

### CROSS-REFERENCES TO RELATED APPLICATIONS

This is a continuation of International Application No. PCT/CN2005/000146, which was filed on Feb. 2, 2005, and which, in turn, claimed the benefit of Chinese Patent Application No. 200410004124.3, which was filed on Feb. 7, 2004, the entire disclosures of which are hereby incorporated herein by reference.

### BACKGROUND OF THE DISCLOSURE

1. Field of the Technology

The invention relates to network communication technology in general, and more specifically, to a method for providing message transmission in H.323 communication system.

2. Background of the Invention

In communication systems, Packet-Based Network (PBN) can not provide a guaranteed quality of service (QoS) and secure service due to technical reasons of itself, which makes PBN become a kind of network without QoS guarantee and security guarantee. The security of H.323 systems, which operate over PBN, therefore involves great concern.

Generally, authentication and privacy techniques are employed by H.323 systems to provide secure services. These authentication and privacy techniques employed by H.323 systems are described in H.235 protocol of Telecommunication Standardization Sector of International Telecommunication Union (ITU-T).

The H.235 protocol of ITU-T describes several security frameworks of authentication and privacy techniques for H.323 systems. At present, the security framework is in general based either on symmetric cryptosystem or on certificate with signatures. The framework based on symmetric cryptosystem, e.g., precontracted password, is simple and easy to be implemented, but the network scalability is poor, requiring that both participants of communication possess a common key in advance. The framework based on certificate with signatures has high security and strong network scalability, but it is complicated to implement and needs support of certification authority institution.

As international standards, the security frameworks for H.323 systems provided by H.235 protocol of ITU-T are not described in detail hereinafter. Please refer to H.235 protocol of ITU-T to obtain detailed description.

H.323 systems provide two routing modes for H.225 protocol based message transmission: Gatekeeper (GK)-routed model and direct-routed model. In the GK-routed model, H.225 protocol messages between two endpoints are transferred through GKs. In the direct-routed model, H.225 protocol messages between two terminals are exchanged directly, rather than transferred through GKs, so the direct routing mode is also referred to as non GK-routed model.

All the security frameworks in H.235 protocol of ITU-T described above aim at technical schemes of security guarantee in the GK-routed model, and so far there has been no specific solution put forward for technique schemes of security guarantee in the non GK-routed model in H.235 protocol of ITU-T. Since the non GK-routed model is very important and widely used in H.323 systems, H.225 protocol message transmission in the non GK-routed model also needs security guarantee.

### SUMMARY OF THE INVENTION

The present invention provides a method for providing message transmission in H.323 communication system.

The method for providing message transmission in H.323 communication system where first endpoint needs to exchange message with second endpoint includes:
the first endpoint and second endpoint confirming authentication information through a GK;
according to said authentication information, the first endpoint and second endpoint exchanging message directly.

The present invention also provides a method for providing first endpoint and second endpoint with authentication information in a communication system.

According to one aspect, the method for providing first endpoint and second endpoint with authentication information in a communication system includes:
sending, by the first endpoint, an access request (ARQ) message containing first key parameter of the first endpoint to first GK where the first endpoint locates;
upon receiving the ARQ message, sending, by the first GK, a location request (LRQ) message containing the first key parameter to second GK where the second endpoint locates;
upon receiving the LRQ message, sending, by the second GK, an information request (IRQ) message containing the key first parameter to the second endpoint;
upon receiving the LRQ message, the second endpoint getting the first key parameter and generating second key parameter of the second endpoint based on the first key parameter;
the second endpoint generating a share key based on the first key parameter and the second key parameter;
sending, by the second endpoint, an information response request (IRR) message containing the second key parameter to the second GK;
upon receiving the IRR message, sending, by the second GK, an location confirm (LCF) message containing the second key parameter to the first GK;
upon receiving the LCF message, sending, by the first GK, an access confirm (ACF) message containing the second key parameter to the first endpoint;
upon receiving the ACF message, the first endpoint getting the second key parameter and generating the share key based on the first key parameter and the second key parameter.

According to another aspect, the method for providing first endpoint and second endpoint with authentication information in a communication system includes:
ending, by the first endpoint, an access request (ARQ) message containing first key parameter of the first endpoint to a GK where the first endpoint and second endpoint locate;
upon receiving the ARQ message, sending, by the GK, an information request (IRQ) message containing the first key parameter to the second endpoint;
upon receiving the LRQ message, the second endpoint getting the first key parameter and generating second key parameter based on the first key parameter;
the second endpoint generating a share key based on the first key parameter and the second key parameter;
sending, by the second endpoint, an information response request (IRR) message containing the second key parameter to the GK;
upon receiving the IRR message, sending, by the GK, an access confirm (ACF) message containing the second key parameter to the first endpoint;
upon receiving the ACF message, the first endpoint getting the second parameter and generating the share key based on the first key parameter and the second key parameter.

Seen from the description of above mentioned technical scheme provided by the present invention, it is obvious that the authentication information for direct message transmission between different endpoints needs to be confirmed through negotiation, and the authentication information needs to be negotiated through GK in a secure manner so as to guarantee security of negotiated authentication information between different endpoints. Since a GK can perform security authentication to endpoints dominated by the GK, endpoints can also perform security authentication to their home GKs, and different GKs perform mutual authentication to each other. Because the security of RAS messages can be guaranteed, the security of negotiated authentication information can be guaranteed through secure RAS message. The authentication information of the present invention adopts Diffie-Hellman key exchange technology, which needs not to encrypt and decrypt the intermediate key information such as ClearToken, thereby having no special demands for the intermediate entities such as GK in H.323 system and applying no effect to the performance of intermediate entities. When RAS messages are used to negotiate the shared key, there is no need to statically precontract shared key between different endpoints, which not only permits direct secure message transmission between different endpoints, but also increases the scalability of the H.323 network which is poor by using symmetrical key system in H.235 protocol before. Therefore, the present invention designates and provides a secure framework of message transmission in H.323 system in direct routing mode, thereby improving the security of H.323 system.

### BRIEF DESCRIPTION OF THE DRAWINGS

FIG. 1 is a schematic flow illustrating message transmission in a H.323 system in accordance with a preferred embodiment of the present invention.

### DETAILED DESCRIPTION OF THE PREFERRED EMBODIMENTS

The present invention will be described in detail hereinafter with reference to accompanying drawings.

According to a preferred embodiment of the present invention, authentication required information for direct message transmission between different endpoints is confirmed through GK routing, and then different endpoints exchange messages directly based on the negotiated authentication required information.

In this way, the present invention puts forward how to negotiate the authentication information for direct message transmission between different endpoints through message transmission of GK-routed model.

Since H.235 protocol of ITU-T provides secure frameworks for message transmission of GK-routed model in H.323 systems, negotiating the authentication information between different endpoints through message transmission of GK-routed model in the present invention can guarantee the security of negotiating the authentication information.

In the present invention, H.225 protocol RAS message transmission is adopted to negotiate the authentication information for direct message transmission between different endpoints. In order to guarantee the security of negotiated authentication information, the security of RAS message should be guaranteed, so the technical scheme provided by the present invention should be implemented under the condition that the security of RAS message is guaranteed.

Since the RAS message should be transmitted through such network entities as endpoint and GK, in order to guarantee the security of RAS message, the GK should perform security authentication to its dominated endpoints, and these endpoints should perform security authentication to their home GK respectively, leading to the endpoints and their home GK trust in each other. Authentication should be implemented between different GKs to avoid malicious network attacks. Through above authentications, secure transmission of RAS message between different endpoints dominated by the same home GK and different GKs can both be guaranteed.

Direct message transmission between different endpoints includes Q.931 message transmission. Shared key is involved in authentication between different endpoints. Since the key exchange technology based on Diffie-Hellman needs no encryption during the procedure of negotiating shared key between an endpoint of one participator and an endpoint of the other participator, it is adopted in the present invention to negotiate the shared key between different endpoints. In this way, there is no need to encrypt information during the procedure of negotiating the shared key, so the performance of the middle entities such as GK in H.323 systems may not be affected by the negotiating process of the shared key.

In this embodiment, different endpoints are set as Endpoint 1 and Endpoint 2, which adopt direct-routed model, rather than GK-routed model, to implement secure message transmission. In the present embodiment, the steps of determining authentication information for direct message transmission between Endpoint 1 and Endpoint 2 include: firstly, Endpoint 1 transmits its key parameters to Endpoint 2 through GK-routed model, and then Endpoint 2 generates its own key parameters according to the key parameters of Endpoint 1 and transmits its own key parameters to Endpoint 1 through GK-routed model. In this way, a shared key between Endpoint 1 and Endpoint 2 is generated, and when using this shared key, the security of direct-routed Q.931 message transmission between Endpoint 1 and Endpoint 2 can be guaranteed.

The detailed technical scheme of determining the authentication information during direct message transmission between Endpoint 1 and Endpoint 2 provided in this embodiment includes: set home GK of Endpoint 1 as GK1, and Endpoint 1 can load its key parameters in a parameter dhkey of ClearToken, designate in a ClearToken that the ClearToken is transmitted by Endpoint 1 and will be transmitted to Endpoint 2, and then load the ClearToken in a RAS message, say an access request (ARQ) message, where the called address in the ARQ message is the address of Endpoint 2. Endpoint 1 transmits the ARQ message to GK1.

Upon receiving the ARQ message transmitted from Endpoint 1, GK1 decides whether GK1 is the home GK of Endpoint 2 according to the called address in the ARQ message. If GK1 is the home GK of Endpoint 2, i.e., Endpoint 1 and Endpoint 2 belongs to the same GK, GK1 will load the ClearToken contained in the ARQ message in an information request (IRQ) message and transmit the IRQ message to Endpoint 2. If GK1 is not the home GK of Endpoint 2, GK1 should inquire the address of Endpoint 2 through other GKs connected with it. If a GK, say GK2, is connected with GK1, GK1 carries the ClearToken contained in the ARQ message in a location request (LRQ) message and transmits the LRQ message to GK2.

Upon receiving the LRQ message, GK2 can determine that the ClearToken information needs to be transmitted to Endpoint 2 according to the ClearToken contained in the LRQ message. GK2 decides whether it is the home GK of Endpoint 2 according to the called address in the LRQ message, if so, GK2 will load the ClearToken in an information request (IRQ) message and transmit the IRQ message to Endpoint 2 in time; otherwise, GK2 should go on to inquire the address of Endpoint 2 to other GKs connected with it.

Upon receiving the IRQ message transmitted from GK2, Endpoint 2 obtains the key parameters of Endpoint 1 from the dhkey of ClearToken in the IRQ message, generates key parameters of Endpoint 2, computes a session key by Diffie-Hellman algorithm, and then carries the key parameters of Endpoint 2 in dhkey of ClearToken in an information request response (IRR) message. It needs to designate in the ClearToken that the ClearToken is transmitted by Endpoint 2 and will be transmitted to Endpoint 1. Then Endpoint 2 transmits the IRR message to its home GK, GK2.

Upon receiving the IRR message, GK2 determines that the ClearToken will be transmitted to Endpoint 1 according to the ClearToken, i.e., GK2 determines the endpoint which should be responded in the IRR message is Endpoint 1. Then GK2 decides whether it is the home GK of Endpoint 1, if so, Endpoint 1 and Endpoint 2 belong to the same GK, GK2, and GK2 should load the ClearToken of the IRR message in an access confirm (ACF) message and transmit the ACF message to Endpoint 1. If the GK2 is not the home GK of Endpoint 1, Endpoint 1 and Endpoint 2 belong to different GKs, Endpoint 1 belonging to GK1 and Endpoint 2 belonging to GK2. Since a location confirm (LCF) message corresponds to the LRQ message, GK2 should load the ClearToken of the IRR message in the LCF message and transmit the LCF message to GK1. Upon receiving the LCF message from GK2, GK1 determines that the ClearToken needs to be transmitted to Endpoint 1 according to the ClearToken in the LCF message, and carries the ClearToken in an ACF message and transmits the ACF message to Endpoint 1. Endpoint 1 obtains the key parameters of Endpoint 2 from the ClearToken contained in the ACF message. In this way, A shared key between Endpoint 1 and Endpoint 2 is generated and can be used for direct-routed message transmission.

Since H.235 protocol permits various kinds of message authentication to be carried in H.323 message, the technical scheme provided in the present invention is applicable to GK-routed model without any modification, i.e., the endpoints belonging to the same home GK or different home GKs obtain a shared key using the above method, and implement message transmission using the shared key through GK-routed model.

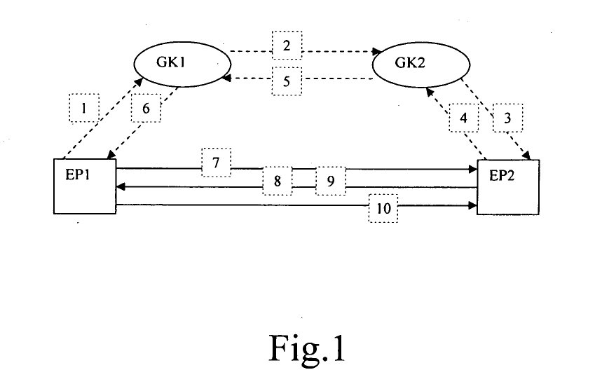

Now, the technical scheme of the present invention will be described in detail hereinafter with reference to FIG. 1.

In FIG. 1, the dashed lines indicate the H.225 protocol based RAS message transmission, and the solid lines indicate the H.235 protocol based Q.931 message transmission. EP1 and EP2 indicate two different endpoints in a H.323 system, and GK1 and GK2 indicate two different GKs in the H.323 system. GK1 is home GK of EP1, and GK2 is home GK of EP2.

In this embodiment of the present invention, GK discovery procedure (GRQ/GCF), endpoint registration procedure (RRQ/RCF) and security negotiation between endpoint and its home GK will not be described in detail. Please refer to H.235 protocol for the detailed description.

Step 1: EP1 carries the desired shared key parameters in ClearToken of an ARQ message, sets the generalID in the ClearToken as EP2, and sets the sendersID in the ClearToken as EP1. In this way, it can be defined that the ClearToken is transmitted from EP1 to EP2. EP1 transmits the ARQ message to its home GK, GK1.

Step 2: Upon receiving the ARQ message, GK1 transforms the ARQ message to a LRQ message and inquires address of EP2 to GK2 since the called endpoint in the ARQ message is EP2 which doesn't belong to GK1. When transforming the ARQ message, GK1 knows that information in the ClearToken is to be transmitted to EP2 according as the generalID in the ClearToken is EP2, so GK1 carries all information in the ClearToken of the ARQ message in the LRQ message, and transmits the LRQ message to GK2.

Step 3: Upon receiving the LRQ message transmitted from GK1, GK2 determines the generalID of ClearToken in the LRQ message is EP2, indicating that GK2 need to transmit the ClearToken information to EP2. Since GK2 is the home GK of EP2, GK2 carries the ClearToken in an IRQ message and then transmits the IRQ message to EP2, thereby transmitting the ClearToken to EP2 in time.

Step 4: Upon receiving the IRQ message transmitted from GK2, EP2 extracts the dhkey parameter of EP1 from the ClearToken of the IRQ message, generates Diffie-Hellman parameter of its own, computes a session key using Diffie-Hellman algorithm, and then sets its own Diffie-Hellman parameter to the dhkey parameter in ClearToken of an IRR message. At last, sets generalID in the ClearToken as EP1, and sets sendersID in the ClearToken as EP2, indicating that the ClearToken is transmitted from EP2 to EP1. After that, EP2 transmits an IRR message to GK2.

Step 5: Upon receiving the IRR message transmitted from EP2, GK2 determines that the ClearToken needs to be transmitted to EP1 according to the generalID contained in the ClearToken of the IRR message. GK2 should load the ClearToken in a message and transmits the message to EP1. GK2 may load the ClearToken in a LCF message which corresponds to the LRQ message in Step 2, and transmit the LCF message to GK1.

Step 6: Upon receiving the LCF message transmitted from GK2, GK1 extracts the ClearToken information contained in the LCF message and knows that the ClearToken should be transmitted to EP1 according to generalID in the ClearToken, so GK1 carries the ClearToken information in an ACF message and transmits the ACF message to EP1.

Upon receiving the ACF message transmitted from GK1, EP1 obtains Diffie-Hellman parameters of EP2 from the ClearToken of the ACF message, and then computes a session key using Diffie-Hellman algorithm. In this way, a shared key between EP1 and EP2 is generated through Diffie-Hellman key exchange, and the shared key is expressed as ShareddKeyEp1Ep2. After the shared key between EP1 and EP2 is generated, the security of direct message transmission between EP1 and EP2 can be guaranteed.

The method for applying key during direct message transmission between EP1 and EP2 is the same as the specification of H.235 protocol, which will be illustrated as Step 7 to Step 10:

Step 7: EP1 encrypts a call setup request (Setup) message using ShareddKeyEp1Ep2 and then directly transmits the Setup message to EP2.

Step 8: Upon receiving the Setup message directly transmitted from EP1, EP2 performs authentication to the transmitting party of the Setup message, EP1, using ShareddKeyEp1Ep2, and if authentication is successful, EP2 encrypts an Altering message using ShareddKeyEp1Ep2, and directly transmits the encrypted Altering message to EP1.

Step 9: EP2 encrypts a call connection message using ShareddKeyEp1Ep2 and directly transmits the encrypted call connection message to EP1.

Step 10: When any party of EP1 and EP2 desires to release the call connection, the initiating party of release will encrypt a call release message using ShareddKeyEp1Ep2 and directly transmit the encrypted call release message to the other party. For example, EP1 desires to release the call connection, and then EP1 encrypts the call release message using ShareddKeyEp1Ep2 and directly transmits the encrypted call release message to EP2.

Step 1 to Step 10 in the embodiment describe a method for securing direct message transmission between two endpoints which belong to different GKs. The method is also adopted to secure direct message transmission between two endpoints which belong to the same GK, and under this condition, since EP1 and EP2 belong to the same GK, i.e., GK1 and GK2 is the same GK, Step 2 and Step 5 can be skipped, with other steps reserved, which will not be illustrated in detail.

To sum up, what is said above is just a relatively preferred embodiment of the present invention. It is not intended to limit the protection scope of the present invention.

1. A method for providing message transmission in H.323 communication system where first endpoint needs to exchange message with second endpoint, comprising:
the first endpoint and second endpoint confirming authentication information through a GK;
according to said authentication information, the first endpoint and second endpoint exchanging message directly.

2. The method according to claim 1, wherein the message comprises Q.931 messages.

3. The method according to claim 1, wherein the authentication information comprises key information.

4. The method according to claim 3, wherein the key comprises a shared key generated by Diffie-Hellman algorithm.

5. The method according to claim 1, wherein the step of confirming authentication information comprises:
the first endpoint transmitting a Registration, Admissions, and Status (RAS) message containing first key parameter of the first endpoint to the second endpoint through home GK of the first endpoint and home GK of the second endpoint;
upon receiving the RAS message sent from the first endpoint, the second endpoint obtaining the first key parameter contained in the RAS message, generating second key parameter of the second endpoint, loading the second key parameter in a RAS message and sending the RAS message to the first endpoint through the home GK of the first endpoint and the home GK of the second endpoint;
the first endpoint and the second endpoint generating a shared key based on the first key parameter and the second key parameter.

6. The method according to claim 5, wherein the step of the first endpoint transmitting a RAS message containing the first key parameter to the second endpoint comprises:
the first endpoint loading the first key parameter in ClearToken of an access request (ARQ)message, and transmitting the ARQ message to the home GK of the first endpoint;
upon receiving the ARQ message, the GK of the first endpoint determining whether it is the home GK of the second endpoint in the ARQ message, if it is, loading the ClearToken in an information request (IRQ) message by the GK and transmitting the IRQ message to the second endpoint; otherwise, loading the ClearToken in a location request (LRQ) message and transmitting the LRQ message to the home GK of the second endpoint;
upon receiving the LRQ message from the home GK of the first endpoint, the home GK of the second endpoint loading the ClearToken in an IRQ message and transmitting the IRQ message to the second endpoint.

7. The method according to claim 6, wherein the step of transmitting the LRQ message to the home GK of the second endpoint comprises:
transmitting the LRQ message to a GK connected with the home GK of the first endpoint;
upon receiving the LRQ message, the GK connected with the home GK of the first endpoint forwarding the LRQ message to the home GK of the second endpoint.

8. The method according to claim 6, wherein generalID in the ClearToken is configured as the second endpoint; sendersID in the ClearToken is configured as the first endpoint.

9. The method according to claim 5, wherein the step of the second endpoint receiving the RAS message, obtaining the first key parameter, generating second key parameters of the second endpoint, loading the second key parameter in a RAS message and sending the RAS message to the first endpoint comprises:
upon receiving the RAS message transmitted through the GK, the second endpoint obtaining the first key parameter according to information contained in the RAS message, and generating second key parameter of the second endpoint according to the first key parameter;
the second endpoint loading the second key parameter in a ClearToken of an information request response (IRR) message, and transmitting the IRR message to the home GK of the second endpoint; the home GK of the second endpoint deciding whether it is the home GK of the first endpoint in the information response message;
if the GK is the home GK of the first endpoint, loading the ClearToken in an access confirm (ACF) message by the GK of the second endpoint and transmitting the ACF message to the first endpoint; upon receiving the ACF message, the first endpoint obtaining the second key parameter according to information of the ClearToken;.
if the GK is not the home GK of the first endpoint, the GK of the second endpoint loading the ClearToken in a location confirm (LCF) message and transmitting the LCF message to the GK of the first endpoint; upon receiving the LCF message, the GK of the first endpoint loading the ClearToken in an ACF message and transmitting the ACF message to the first endpoint; upon receiving the ACF message, the first endpoint obtaining the second key parameter according to information of the ClearToken.

10. The method according to claim 9, wherein generalID in the ClearToken is configured as the first endpoint; sendersID in the ClearToken is configured as the second endpoint.

11. The method according to claim 5, wherein the step of exchanging message directly comprises:
the first endpoint directly sending a call setup request message to the second endpoint using the shared key;
upon receiving the call setup request message, the second endpoint performing authentication to the first endpoint according to the shared key, and sending an Alerting message and a call connection message to the first endpoint which passed the authentication using the shared key.

12. The method according to claim 11, further comprising:
after the call connection is established, the first endpoint sending a call release message to the second endpoint using the shared key when the first endpoint desires to release the call connection; or the second endpoint sending a call release message to the first endpoint using the shared key when the second endpoint desires to release the call connection.

13. A method for providing first endpoint and second endpoint with authentication information in a communication system, the method comprising:
sending, by the first endpoint, an access request (ARQ) message containing first key parameter of the first endpoint to first GK where the first endpoint locates;
upon receiving the ARQ message, sending, by the first GK, a location request (LRQ) message containing the first key parameter to second GK where the second endpoint locates;
upon receiving the LRQ message, sending, by the second GK, an information request (IRQ) message containing the key first parameter to the second endpoint;
upon receiving the LRQ message, the second endpoint getting the first key parameter and generating second key parameter of the second endpoint based on the first key parameter;
the second endpoint generating a share key based on the first key parameter and the second key parameter;
sending, by the second endpoint, an information response request (IRR) message containing the second key parameter to the second GK;
upon receiving the IRR message, sending, by the second GK, an location confirm (LCF) message containing the second key parameter to the first GK;
upon receiving the LCF message, sending, by the first GK, an access confirm (ACF) message containing the second key parameter to the first endpoint;
upon receiving the ACF message, the first endpoint getting the second key parameter and generating the share key based on the first key parameter and the second key parameter.

14. The method according to claim 13, wherein the first key parameter is contained in ClearToken of the ARQ message, the LRQ message and the IRR message respectively;
generalID in the ClearToken is configured as the second endpoint; sendersID in the ClearToken is configured as the first endpoint.

15. The method according to claim 13, wherein the second key parameter is contained in ClearToken of the IRR message, the LCF message and the ACF message respectively;
generalID in the ClearToken is configured as the first endpoint; sendersID in the ClearToken is configured as the second endpoint.

16. A method for providing first endpoint and second endpoint with authentication information in a communication system, the method comprising:
sending, by the first endpoint, an access request (ARQ) message containing first key parameter of the first endpoint to a GK where the first endpoint and second endpoint locate;
upon receiving the ARQ message, sending, by the GK, an information request (IRQ) message containing the first key parameter to the second endpoint;
upon receiving the LRQ message, the second endpoint getting the first key parameter and generating second key parameter based on the first key parameter;
the second endpoint generating a share key based on the first key parameter and the second key parameter;
sending, by the second endpoint, an information response request (IRR) message containing the second key parameter to the GK;
upon receiving the IRR message, sending, by the GK, an access confirm (ACF) message containing the second key parameter to the first endpoint;
upon receiving the ACF message, the first endpoint getting the second parameter and generating the share key based on the first key parameter and the second key parameter.

17. The method according to claim 16, wherein the first key parameter is contained in ClearToken of the ARQ message, the LRQ message and the IRR message respectively;
generalID in the ClearToken is configured as the second endpoint; sendersID in the ClearToken is configured as the first endpoint.

18. The method according to claim 16, wherein the second key parameter is contained in ClearToken of the IRR message, the LCF message and the ACF message respectively;
generalID in the ClearToken is configured as the first endpoint; sendersID in the ClearToken is configured as the second endpoint.
